(19) United States
(12) Patent Application Publication
(10) Pub. No.: US 2025/0010239 A1
(43) Pub. Date: Jan. 9, 2025

(54) SYSTEMS AND METHODS FOR NATURAL GAS POWER GENERATION AND CARBON-CAPTURE OF THE SAME

(71) Applicant: Georgia Tech Research Corporation, Atlanta, GA (US)

(72) Inventors: Matthew J. Realff, Atlanta, GA (US); Fani Boukouvala, Atlanta, GA (US); Howard Land Hendrix, Atlanta, GA (US); Christopher W. Jones, Atlanta, GA (US); Ryan P. Lively, Atlanta, GA (US); Joseph Scott, Atlanta, GA (US); David Thierry, Atlanta, GA (US); Pengfei Cheng, Atlanta, GA (US)

(21) Appl. No.: 18/709,684

(22) PCT Filed: Nov. 17, 2022
(86) PCT No.: PCT/US2022/080053

§ 371 Date: May 13, 2024

Related U.S. Application Data
(60) Provisional application No. 63/280,358, filed on Nov. 17, 2021.
(60) Provisional application No. 63/280,606, filed on Nov. 17, 2021.

(51) Int. Cl. B01D 53/62

(52) U.S. Cl. CPC B01D 53/62; B01D 2253/202; B01D 2257/504; B01D 2258/0283

(57) ABSTRACT

Disclosed herein natural gas power generating systems comprising a post-combustion carbon capture (PCC) unit configured to remove carbon dioxide from a waste gas to create a flue gas, a direct air capture (DAC) unit configured to adsorb carbon dioxide from an atmospheric gas, and a compression unit configured to receive at least one of: (i) carbon dioxide gas from the first carbon dioxide rich outlet line and (ii) carbon dioxide gas from the second carbon dioxide rich outlet line to create a compressed carbon dioxide product. The DAC unit can further generate steam using a heat exchange with steam generated by a HRSG. The DAC unit can further comprise a sorbent module containing the sorbent bed. The sorbent module can have a carbon capture state configured to adsorb carbon dioxide and a regeneration state configured to contact steam with the sorbent bed.

### CROSS-REFERENCE TO RELATED APPLICATIONS

This application claims the benefit of U.S. Provisional Application Ser. No. 63/280,606 and U.S. Provisional Application Ser. No. 63/280,358, both filed on 17 Nov. 2021, the entire contents and substance of each are incorporated herein by reference in their entirety as if fully set forth below.

### STATEMENT OF RIGHTS UNDER FEDERALLY SPONSORED RESEARCH

This invention was made with government support under Award No. DE-AR0001309 by the Advanced Research Projects Agency-Energy (ARPA-E). The government has certain rights in the invention.

### FIELD OF THE DISCLOSURE

The present disclosure relates generally to natural gas power generation and carbon-capture using energy from the same. Particularly, embodiments of the present disclosure relate to systems and methods for cyclic direct air capture (DAC) of carbon dioxide using energy generated by natural gas power generating systems.

### BACKGROUND

Growing concerns about climate change induced by anthropogenic CO₂ accumulation has led to interests in technologies that slow the growth of CO₂ output or in some of the most ideal scenarios, halt the increase in atmospheric CO₂ concentration. Ideally, society would rapidly switch to renewable energy sources such as wind, solar geothermal and biomass-derived energy because these non-fossil fuels-based energy sources are carbon-neutral. However, given the scale of society's energy needs, it will be many decades before renewable fuels can bear the majority of the burden of powering our planet. In the meantime, fossil energy will continue to supply the bull of the energy demand. In such a scenario, the atmospheric CO₂ level will continue to climb above the current concentration of approximately 417 ppm.

One approach to capture CO₂ from fossil fuel combustion is to trap CO₂ at large point sources such as electricity generating power plants. However, roughly ⅓ of global carbon emissions are associated with distributed sources such as transportation fuels. Thus, large-scale deployment of carbon capture and sequestration (CCS) technologies at various point sources can at best slow the rate of increase of the atmospheric CO₂ concentration. What is needed is a carbon-negative technology, one that actually reduces the concentration of CO₂ in the atmosphere. Here, building on the limited existing work, the present disclosure can provide the direct capture of carbon dioxide from the ambient air using solid adsorbents specifically designed for this task as a new approach for reducing the concentration of CO₂ in the ambient air. The direct air capture can be integrated with energy available at low cost from a natural gas power plant to be economically viable. The captured CO₂ could be sequestered semi-permanently, for example, underground, or used in a beneficial application, such as a feedstock for algae-based biofuels production.

Direct capture of CO₂ from the air is an alternate technology to the capture of CO₂ from large point sources, and this has the advantage that it can address CO₂ emissions from all sources if the technology is operated on a sufficiently large scale. However, this presents the technical challenge to develop adsorbents that operate near ambient conditions and that can extract CO₂ from ultra-dilute sources with CO₂ concentrations ranging from 200 to 600 parts per million (ppm).

Therefore, there is a need in the industry to overcome at least some of the aforementioned inadequacies and deficiencies.

What is needed, therefore, are carbon capture systems and methods that can accommodate current natural gas power generating systems, either anew or retrofit, to dynamically adjust carbon capture levels based on electricity demand. Embodiments of the present disclosure address this need as well as other needs that will become apparent upon reading the description below in conjunction with the drawings.

### BRIEF SUMMARY OF THE DISCLOSURE

The present disclosure relates generally to natural gas power generation and carbon-capture using energy from the same. Particularly, embodiments of the present disclosure relate to systems and methods for cyclic direct air capture (DAC) of carbon dioxide using energy generated by natural gas power generating systems.

An exemplary embodiment of the present disclosure can provide a natural gas power generating system comprising: a gas turbine configured to generate power and generate a waste gas as a result of a combustion reaction between natural gas and air, the gas turbine comprising an air inlet, a natural gas inlet, and a gas turbine outlet line; a heat recovery steam generator (HRSG) configured to recover heat from the waste gas by transferring heat energy from the waste gas to water to generate steam, the HRSG comprising a waste gas inlet line connected to the gas turbine outlet line, a plurality of steam outlet lines, and an HSRG outlet line; a post-combustion carbon capture (PCC) unit configured to remove carbon dioxide from the waste gas to create a flue gas, the PCC unit comprising a PCC inlet line connected to the HSRG outlet line, a flue gas outlet line, and a first carbon dioxide rich outlet line; and a direct air capture (DAC) unit comprising a DAC steam generating system configured to conduct a heat exchange with at least a portion of steam from the plurality of steam outlet lines, the DAC unit being configured to adsorb carbon dioxide from an atmosphere stream, and the DAC unit further comprising a sorbent bed, an atmosphere inlet line, a second carbon dioxide rich outlet line, and a stack outlet line, wherein the first carbon dioxide rich outlet line and the second carbon dioxide rich outlet line transport carbon dioxide product removed by the PCC and the DAC, and the stack outlet line and the flue gas outlet line are vented to the atmosphere.

In any of the embodiments disclosed herein, the natural gas power generating system can further comprise a plurality of steam turbines configured to generate power from the steam generated by the HRSG, wherein the plurality of steam outlet lines comprise a high pressure outlet, an intermediate pressure outlet, and a low pressure outlet, each of which is configured transport steam from the HRSG to the plurality steam turbines.

In any of the embodiments disclosed herein, the high pressure outlet can feed into a high pressure (HP) turbine, the intermediate pressure outlet can feed into an intermediate pressure (IP) turbine, and the low pressure outlet can feed to a low pressure (LP) turbine, wherein the LP turbine comprises an IP/LP crossover configured to transport additional steam from the IP turbine to the LP turbine.

In any of the embodiments disclosed herein, the IP/LP crossover can comprise a carbon capture steam line configured to transport steam from the IP/LP crossover to the PCC unit.

In any of the embodiments disclosed herein, the natural gas power generating system can further comprise a DAC steam generation system comprising a heat exchanger configured to generate steam from the exchange of heat from steam generated by the HRSG.

In any of the embodiments disclosed herein, the DAC unit can comprise a sorbent module containing the sorbent bed, wherein the sorbent module has: (i) a carbon capture state wherein the sorbent module is configured to adsorb carbon dioxide on the sorbent bed, and (ii) a regeneration state wherein the sorbent module is configured to contact steam from the DAC steam generation system with the sorbent bed.

In any of the embodiments disclosed herein, the DAC unit can automatically transition the sorbent module from the carbon capture state to the regeneration state when the sorbent bed is at least partially saturated with carbon dioxide.

In any of the embodiments disclosed herein, the DAC unit can automatically transition the sorbent module from the carbon capture state to the regeneration state when the sorbent bed is at least partially saturated with carbon dioxide, and a rate at which steam contacts the sorbent bed in the regeneration state is altered based on a price of electricity produced by the natural gas power generating system.

In any of the embodiments disclosed herein, the DAC unit can further comprise a plurality of sorbent modules, each of which contains a sorbent bed, wherein each sorbent module is either in the carbon capture state or the regeneration state.

In any of the embodiments disclosed herein, the steam generated by the HSRG can be configured to provide steam to the heat exchanger in the DAC steam generation system in the regeneration state, and at least a portion of the steam generated by the HSRG is further configured to simultaneously be provided to the PCC.

In any of the embodiments disclosed herein, the second carbon dioxide rich line can be fed to a purification unit to produce the carbon dioxide product removed by the DAC, and wherein the system can further comprise a compression unit configured to compress the carbon dioxide from the DAC and the PCC.

In any of the embodiments disclosed herein, the compression unit can comprise a first compression unit configured to compress carbon dioxide from the DAC and a second compression unit configured to compress carbon dioxide from the PCC.

Another embodiment of the present disclosure can provide a natural gas power generating system comprising: a post-combustion carbon capture (PCC) unit configured to remove carbon dioxide from a waste gas to create a flue gas, the PCC unit comprising a waste gas inlet line, a flue gas outlet line, and a first carbon dioxide rich outlet line; a direct air capture (DAC) unit configured to adsorb carbon dioxide from an atmospheric gas, the DAC unit comprising a sorbent bed, an atmosphere inlet line, a second carbon dioxide rich outlet line, and a stack outlet line; and a compression unit configured to receive at least one of: (i) carbon dioxide gas from the first carbon dioxide rich outlet line and (ii) carbon dioxide gas from the second carbon dioxide rich outlet line to create a compressed carbon dioxide product, wherein the stack outlet line is vented to the atmosphere by a stack.

In any of the embodiments disclosed herein, the natural gas power generating system can further comprise: a plurality of steam turbines configured to generate power from steam; and a heat recovery steam generator (HRSG) comprising a high pressure outlet, an intermediate pressure outlet, and a low pressure outlet, each of which is configured transport steam from the HSRG to the plurality of steam turbines.

In any of the embodiments disclosed herein, the high pressure outlet can feed into a high pressure (HP) turbine, the intermediate pressure outlet can feed into an intermediate pressure (IP) turbine, and the low pressure outlet can feed to a low pressure (LP) turbine, wherein the LP turbine comprises an IP/LP crossover configured to transport additional steam from the IP turbine to the LP turbine.

In any of the embodiments disclosed herein, the IP/LP crossover can comprise a carbon capture steam line configured to transport steam from the IP/LP crossover to the PCC unit.

In any of the embodiments disclosed herein, the natural gas power generating system can further comprise a DAC steam generation system comprising a heat exchanger configured to generate steam from the exchange of heat from steam generated by the HRSG.

In any of the embodiments disclosed herein, the DAC unit can comprise a sorbent module containing the sorbent bed, wherein the sorbent module has: (i) a carbon capture state wherein the sorbent module is configured to adsorb carbon dioxide on the sorbent bed, and (ii) a regeneration state wherein the sorbent module is configured to contact steam from the DAC steam generation system with the respective sorbent bed.

In any of the embodiments disclosed herein, the DAC unit can automatically transition the sorbent module from the carbon capture state to the regeneration state when the respective sorbent bed is at least partially saturated with carbon dioxide.

In any of the embodiments disclosed herein, the DAC unit can automatically transition the sorbent module from the carbon capture state to the regeneration state when the sorbent bed is at least partially saturated with carbon dioxide, and a rate at which steam contacts the sorbent bed in the regeneration state is altered based on a price of electricity produced by the natural gas power generating system.

In any of the embodiments disclosed herein, the steam generated by the HSRG can be configured to provide steam to the heat exchanger in DAC steam generation system in the regeneration state, and at least a portion of the steam generated by the HSRG can be further configured to simultaneously be provided to the PCC.

Another embodiment of the present disclosure can provide a method for the capture of carbon dioxide, the method comprising: combusting a natural gas to obtain a waste gas stream containing carbon dioxide, the combustion reaction generating heat to generate steam; using at least a portion of the generated steam to generate power through a steam turbine; feeding the waste gas stream containing the carbon dioxide to a post-combustion carbon capture (PCC) unit; cleaning the waste gas stream to obtain a flue gas stream containing a concentration of carbon dioxide less than the concentration of carbon dioxide in the waste gas stream; feeding an atmosphere stream to a direct air capture (DAC) unit comprising a plurality of sorbent modules, each of which comprises a sorbent bed, the atmosphere stream comprising carbon dioxide from the atmosphere; and passing the atmosphere stream over the sorbent bed in each of the plurality of sorbent modules to obtain a stack stream containing a concentration of carbon dioxide less than the concentration of carbon dioxide in the atmosphere stream.

In any of the embodiments disclosed herein, the method can further comprise: responsive to a demand in electricity falling below a predetermined threshold, diverting the at least a portion of generated steam from the steam turbine to a steam generation system connected to the DAC unit; conducting a heat exchange between the at least a portion of generated steam and a regeneration portion of steam contained in the steam generation system; automatically stopping the atmosphere stream from being fed into the DAC unit; and regenerating the sorbent beds in a portion of the plurality of sorbent modules by contacting the regeneration portion of steam from the steam generation system with the sorbent beds to obtain a concentrated carbon dioxide stream.

In any of the embodiments disclosed herein, the method can further comprise: responsive to the demand in electricity rising above the predetermined threshold, automatically resuming the feeding of the atmosphere stream to the portion of the plurality of sorbent modules; and re-diverting the at least a portion of generated steam to the steam turbine.

In any of the embodiments disclosed herein, the concentration of carbon dioxide in the atmosphere stream can be in the range from 100 to 1000 ppm.

In any of the embodiments disclosed herein, the passing the atmosphere stream over the sorbent bed can occur at a substantially ambient temperature of not greater than 60° C.

These and other aspects of the present disclosure are described in the Detailed Description below and the accompanying figures. Other aspects and features of embodiments of the present disclosure will become apparent to those of ordinary skill in the art upon reviewing the following description of specific, exemplary embodiments of the present invention in concert with the figures. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1A is a process flow diagram of a natural gas power generating system in accordance with the present disclosure.

FIG. 1B is a process flow diagram of a heat recovery steam generator (HSRG) in a natural gas power generation system, in accordance with the present disclosure.

FIG. 2 is a flowchart of a method for the capture of carbon dioxide, in accordance with the present disclosure.

FIG. 3 is another flowchart of a method for the capture of carbon dioxide, in accordance with the present disclosure.

FIGS. 4A-C are process flowsheets for a natural gas power generation system at various power outputs, in accordance with the present disclosure.

FIG. 5 is a plot of generated electrical power against percentage of steam sent to the DAC in a natural gas power generation system, in accordance with the present disclosure.

FIG. 6 is a plot of DAC steam generation against percentage of steam sent to the DAC in a natural gas power generation system, in accordance with the present disclosure.

FIG. 7 is a block diagram of a post-combustion carbon capture (PCC) and compression system in a natural gas power generation system, in accordance with the present disclosure.

### DETAILED DESCRIPTION

The present disclosure can provide a flexible system which could either maximize the CO₂ removal or maximize electrical power based on the current economic conditions. To accommodate this goal, the conventional natural gas carbon capture (NGCC) IP/LP crossover duct can be replaced with a LP steam distribution system. The LP steam system supplied steam to a variety of systems. The steam for the PCC unit regenerator reboiler can be supplied from the LP steam system. The amount of steam supplied can depend on the amount of methane combusted in the gas turbine and the CO₂ produced. Therefore, the steam flow to the PCC system can be dependent on the gas turbine load.

The steam for the DAC system can be generated using LP steam. If the price for removing CO₂ is high relative to that of electrical power, the LP steam that is not utilized by the PCC system can flow to the DAC Steam Generation system to produce steam for the DAC system.

If the price for removing CO₂ is low relative to that of electrical power, the LP steam not utilized by the PCC system can flow to the LP turbine to generate electricity.

The steam generated in the DAC Steam Generation System can be a separate loop than that of the HRSG steam/condensate system for the following reasons: (i) the steam pressure used by the DAC system can be low (<10 psig), therefore, the water quality requirements can be lower than that required by the HRSG; (ii) approximately half of the steam supplied to the DAC system can be lost to the atmosphere during regeneration. If the water was taken from the HRSG steam cycle, the size of the water treatment system would have to be substantially increased to provide this degree of makeup; and (iii) the recovered DAC condensate can be saturated with CO₂ and would be acidic. Maintaining the HRSG water chemistry when combining the HRSG and DAC condensate with this concentration of CO₂ in the water would be challenging.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

The present disclosure can be used as, or in conjunction with, a retrofit design of a natural gas combined cycle plant (e.g., turbines in a 2×1 configuration) to integrate post-combustion (PCC) and direct air carbon capture (DAC) systems that can produce power with negative emissions across a wide range of loads. The IP/LP crossover and LP steam system of the NGCC can be reconfigured to enable 97% CO₂ capture in the PCC system at all loads, and heat integration with the DAC can reduce the parasitic load of carbon capture by recovering the heat of condensation of the steam.

The disclosed systems and methods can further be dispatched on a grid that can have heavy penetration of renewable power, an illustrative example of which is set forth herein. The dispatch of such an integrated plant can be optimized across different electricity price signals and carbon prices to calculate a net present value assuming, for instance, a capital return factor of 0.12 and a depreciation schedule of 20 years. The NPV can be positive at carbon prices that, for instance, exceed $225/tonne with the assumed price signals. The retrofit plant can be dispatched 39% of the time compared to a base case plant 33% of the time at carbon prices of, for instance, $150/tonne. The LCOE results can show that a CO₂ price of, for example, $162/tonne CO₂ can be used for the retrofit to obtain a $75/MWh LCOE value with estimated costs.

The DAC fiber sorbent system can comprise, for instance, low-cost cellulose acetate, silica particles and polyethylene imine sorbent. Using a 20 wt % solution of polyamine such as polyethyleneimine (PEI) to impregnate the fibers, a pseudo-equilibrium performance of 0.65 mmol CO₂/g fiber can be obtained on dry simulated air at 25° C. and 1.04 mmol CO₂/fiber with 50% humidity indoor air. It can be found that 10 wt % solution fibers can have the best kinetic uptake and can achieve a productivity of 1.05 mmol/g fiber/hr with realistic air velocities of 1 m/sec and assuming 20% loss of CO₂ during desorption. 99% of the CO₂ can be desorbed during the first five minutes of desorption.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

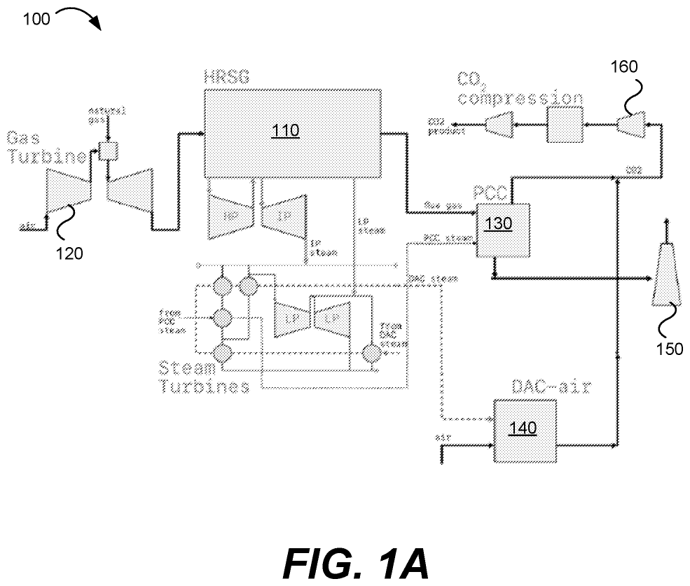

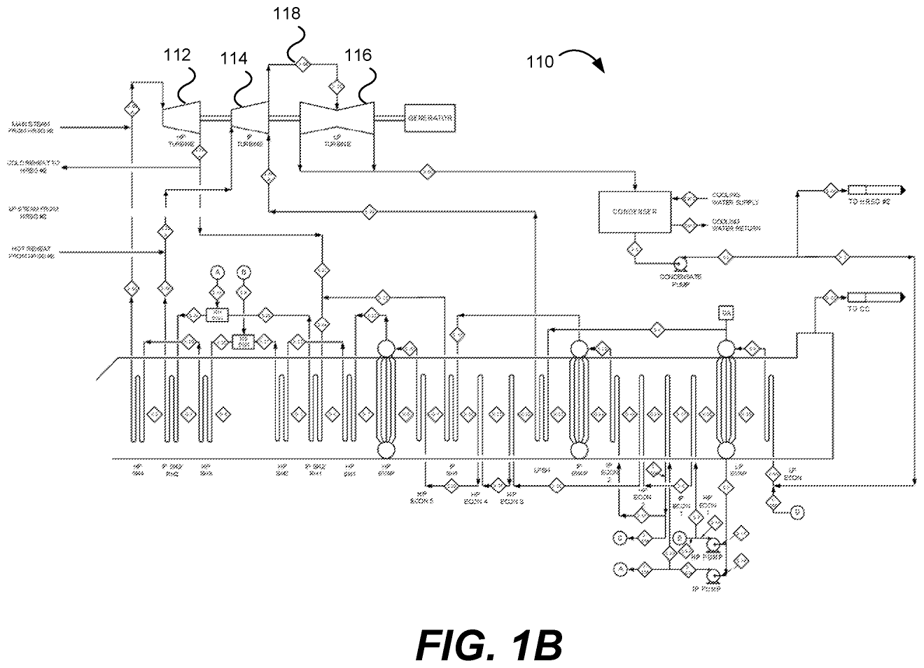

As shown in FIG. 1A, the disclosed natural gas power generating systems 100 can comprise a heat recovery steam generator (HSRG) 110. As would be appreciated, power generation systems can generate power from the combustion of natural gas. This combustion reaction can release energy in a gas turbine 120 to generate power. Additionally, the combustion of natural gas can create a waste gas comprising combustion products at a high temperature. This high temperature waste gas can be transported to the HSRG 110 where the waste gas can conduct a heat exchange with water to generate steam. In such a heat exchange, the temperature of the waste gas can be decreased as energy is used to create steam in the HSRG 110. The steam generation is further illustrated in FIG. 1B as will be described below.

The waste gas, upon exiting the HSRG 110, can be transported to a post-combustion carbon capture (PCC) unit 130. The PCC unit 130 can be configured to remove CO₂ from the waste gas to create a CO₂-rich outflow and a flue gas outflow. As would be appreciated, the CO₂ removal in the PCC unit 130 means that the flue gas outflow can have a lower concentration of CO₂ when compared with the waste gas as the removed CO₂ is contained in the CO₂-rich outflow. The PCC unit 130 can be configured according to a variety of carbon-capture methods, a non-limiting example of which is scrubbing or solvent-based carbon capture or any carbon-capture method suitable for point source CO₂ capture at CO₂ concentrations in the range from 1% to 15% by volume in a gas stream further comprising water, oxygen, nitrogen, and other minor components formed when carbon fuels are combusted.

The natural gas power generating system 100 can further comprise a direct air capture (DAC) unit 140. The DAC unit 140 can be configured to adsorb CO₂ from an air stream obtained from atmosphere. The DAC unit 140 can be configured in a number of ways, but the DAC unit 140 can utilize one or more sorbent beds to adsorb atmospheric CO₂. Thus, the DAC unit 140 can generate another CO₂-rich outflow and a stack outflow. As would be appreciated, the CO₂ removal in the DAC unit 140 means that the stack outflow can have a lower concentration of CO₂ when compared to the atmospheric air inlet stream as the removed CO₂ is contained in the CO₂-rich outflow. Thus, the stack outflow can be vented back to the atmosphere via a stack 150 along with the flue gas outflow generated by the PCC unit 130. Alternatively, the stack outflow from the DAC unit 140 need not proceed through the stack 150. For instance, the stack outflow can be vented directly back to the atmosphere from the DAC unit 140.

The CO₂-rich outflow from the DAC unit 140 and the CO₂-rich outflow from the PCC unit 130 can both be transported to a CO₂ compression unit 160 where the CO₂ streams can be purified and compressed to form a CO₂ product.

Furthermore, the steam generated by the HSRG 110 can be used to conduct a heat exchange with additional water to generate additional steam for the DAC unit 140. The generated steam from the heat exchange can be used to regenerate the one or more sorbent beds in the DAC unit 140. As would be appreciated, the sorbent bed in the DAC unit 140 can sorb CO₂ as the atmospheric air passes over the sorbent bed. Over time, the sorbent bed can become saturated with CO₂ that was removed from the atmospheric air. Passing steam over the sorbent bed thereafter can remove the sorbed CO₂ from the sorbent bed, thereby regenerating the sorbent bed so the sorbent bed can begin sorbing CO₂ once more. The CO₂ pulled off the sorbent bed by the steam can then be transported elsewhere, such as to a purification step and/or a compression step, for further processing.

Therefore, in addition, the natural gas power generating unit 100 can comprise a DAC steam generation system. The DAC steam generation system can include a heat exchanger through which steam from the HSRG 110 exchanges heat with the DAC steam drum to generate additional steam for the DAC unit 140. In such a manner, excess heat energy from the HSRG 110 can be put to use generating additional steam that can be used for carbon capture in the DAC unit 140.

As would be appreciated, the carbon capture in the DAC unit 140 can be driven by the one or more sorbent beds. Therefore, the DAC unit 140 can have a carbon capture state in which CO₂ is adsorbed onto the sorbent bed. The DAC unit 140 can also have a regeneration state in which steam is contacted with the sorbent bed to remove adsorbed CO₂. The DAC unit 140 can automatically transition from the carbon capture state to the regeneration state when the sorbent bed is at least partially saturated and/or fully saturated. Alternatively, or in addition, other triggering events are contemplated that can be used as desired to transition from the carbon capture state to the regeneration state, examples of which are described in greater detail below.

Accordingly, it is contemplated that the DAC unit 140 can comprise multiple sorbent beds. In such a case, each sorbent bed can individually either be in the carbon capture state or the regeneration state. Furthermore, each sorbent bed can individually be in a fully saturated or sorbed state and/or a partially saturated or sorbed state. In addition, each sorbent bed can individually be in a fresh state once regeneration is completed, and no CO₂ has been adsorbed. The sorbent beds can move in concert with one another where at least one sorbent bed is in the carbon capture state, at least one sorbent bed is in the regeneration state, and the regeneration ends prior to the sorbent beds reaching saturation in the carbon capture state such that the sorbent bed can be in the fresh state ready to enter the carbon capture state. In such a manner, the DAC unit 140 can continuously provide for the removal of CO₂ from atmospheric air.

Therefore, the steam generated in the DAC steam generation system can be called upon to generate steam when one or more sorbent beds are in the regeneration state. The configuration of the sorbent beds can be a cascade (the sorbent beds cycle individually so that all states are present) or a batch (multiple sorbent beds operate in the carbon capture state and then simultaneously transition to the regeneration state).

In such a manner, the DAC unit 140 can comprise one or more sorbent modules, each comprising a sorbent bed. Each sorbent module can receive atmospheric air or steam depending on the present state of the sorbent bed therein. For example, a sorbent module can receive steam once the sorbent bed therein is in the saturated state in order to regenerate the sorbent bed. As another example, a sorbent module can receive atmospheric air once the sorbent bed therein is in the fresh state in order to begin CO₂ removal.

Various examples of a sorbent bed can be used. As a nonlimiting example, the sorbent bed can comprise an amine adsorbent, the amine being selected from the group consisting of hyperbranched aminopolymers. Alternatively, or in addition, the sorbent bed can comprise an amine derived from the group consisting of hyperbranched aminopolymers and a silylamine prepared by the reaction of a silyl diamine with an oxide substrate.

As shown in FIG. 1B, the HSRG 110 can comprise a plurality of steam turbines. The HSRG 110 can generate steam which can be generated and transported to a high pressure (HP) turbine 112, an intermediate pressure (IP) turbine 114, and a low pressure (LP) turbine 116. The high-pressure steam generated by the HSRG 110 can be transported through the HP turbine 112 and fed back into the HSRG 110 to further exchange heat with and cool the waste gas. In such a manner, the high-pressure steam gets reheated in the HSRG 110. The pressure of steam exiting the HP turbine 112 can be lower than the pressure of steam entering the HP turbine 112. The intermediate pressure steam is then fed to the IP turbine 114. After further decreasing in pressure in the IP turbine 114, the now-low-pressure steam is transported through an IP/LP crossover 118 to the LP turbine 116.

Steam from the plurality of steam turbines can also be sent to the PCC unit 130. The PCC unit 130 can use the steam to aid in carbon capture. The PCC unit 130 can adjust the level of carbon capture based on the gas turbine 120 output level. In such a manner, the PCC unit 130 can capture as much CO₂ as it can from the flue gas at any gas turbine 120 load. The steam used by the PCC unit 130 can vary based on the waste gas flow from the gas turbine 120.

Similarly, it is steam from the IP/LP crossover 118 that can be rerouted as desired to a heat exchanger where the steam can generate additional steam for the DAC unit 140. All the while, the steam from the HSRG 110 is generating additional power for the natural gas power generating system 100 through the plurality of steam turbines. As such, the steam for the DAC unit 140 can vary depending on the amount of CO₂ capture desired in the DAC unit 140 versus the amount of power generation required by the natural gas power generating system 100 to achieve an economic optimum.

As would be understood, power demand can fluctuate. As such, the power generated by the natural gas power generating system 100 can be modified based on such demand. When power demand is low, for instance, power need not necessarily be generated by the HSRG 110 through the plurality of turbines. As such, additional steam can be rerouted from the IP/LP crossover 118 to the DAC steam drum to help generate additional steam for use in the DAC unit 140. This determination of power demand can be a function of the current price of electricity and a predicted value of electricity over a future time period. Alternatively, or in addition, when the DAC unit 140 has a number of sorbent beds reach the saturated state, the DAC unit 140 can call for additional steam from the IP/LP crossover 118 to help generate steam in the DAC steam generation system.

As would be appreciated, in addition to power demand, the additional steam can be rerouted from the IP/LP crossover 118 to the DAC steam drum based on the status of one or more sorbent modules within the DAC unit 140. The DAC steam drum can generate a baseline steam load for any sorbent modules that are in the saturated state or in the regeneration state. In such a manner, the DAC unit 140 can regenerate such modules while other available sorbent modules can continue to remove CO₂ from an atmospheric air stream. If more sorbent modules reach the saturated state and need to transition to the regeneration state, the natural gas power generating system 100 can reroute additional steam from the IP/LP crossover 118 to the DAC steam drum. Further, as described above, the steam rerouted from the IP/LP crossover 118 to the DAC steam drum can be modulated based on the power demand load placed on the natural gas power generating system 100. As such, the DAC unit 140 can modulate the sorbent modules such that more modules are in the saturated or regenerating state when the power demand on the system is low, and the system can afford to reroute additional steam from the IP/LP crossover 118 to the DAC steam drum. Similarly, the DAC unit 140 can modulate the sorbent modules such that more modules are in the fresh state or carbon capture state when the power demand on the system is high, such that the steam in the IP/LP crossover 118 can be used for power generation instead of being rerouted to the DAC steam drum.

The present disclosure can analyze the heat and material balances for the full load case and can determine approximate sizes of heat exchange equipment.

The present disclosure can further analyze certain examples of extreme operating modes of “Max DAC” and “Max Power” under varying load conditions from 100% to 25% and can ensure that operation can be feasible for all these conditions. This analysis can be extended to four other exemplary cases of larger and smaller gas turbines manufactured by GE, for instance, including two H-class turbines. Going forward, this heat and material balance modeling methodology can support the evaluation of different generating assets. The models can be translated into an overall economic model. As would be appreciated, such a model can assess retrofitting different assets that can apply to any size and/or configuration of NGCC and/or natural gas power generating systems.

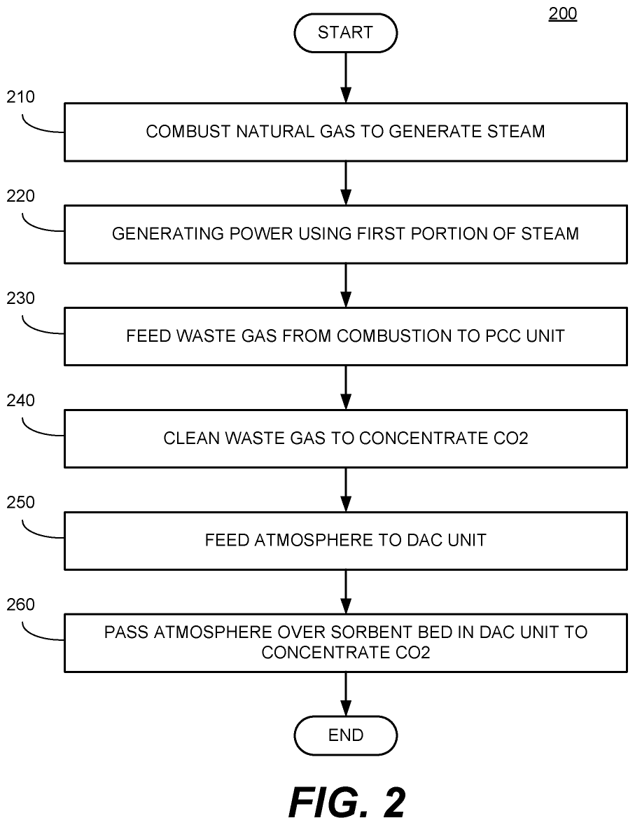

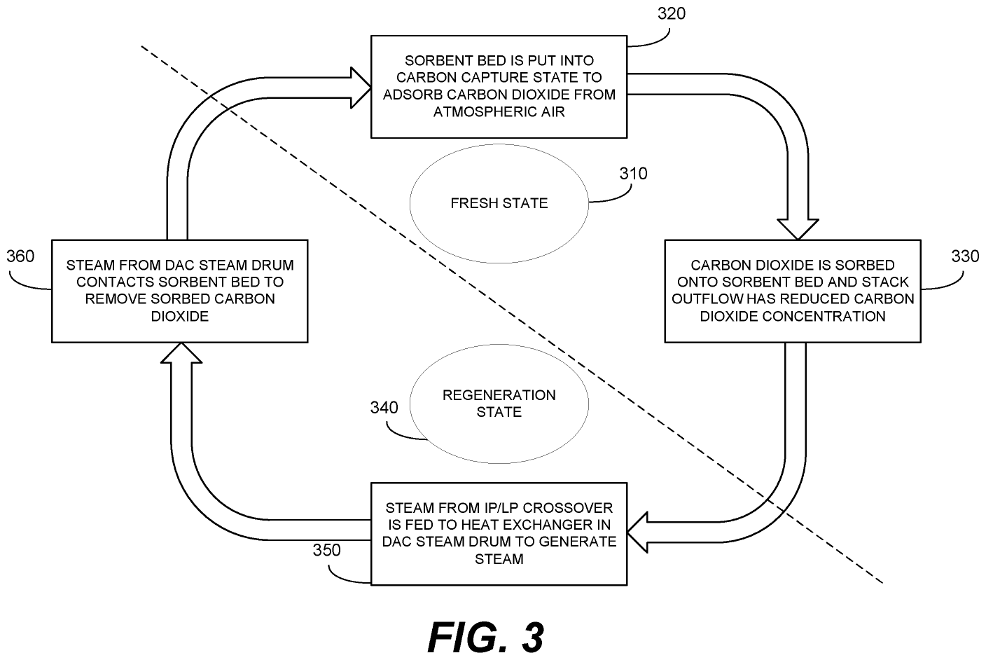

While the following methods in FIGS. 2 and 3 may be described with reference to the natural gas power generating system 100, it is understood that one or more method steps or whole methods can be performed by other systems disclosed herein, other systems, general-purpose computers, computer operators, and the like.

FIG. 2 illustrates a flowchart of a method 200 for the capture of carbon dioxide. As shown, the method 200 can comprise combusting 210 natural gas to obtain a waste gas stream. As a result, the waste gas stream can contain CO₂. The combustion reaction can also generate heat which can, in turn, be used to generate steam. The combustion reaction can occur in the gas turbine 120, where the energy released from the combustion reaction can be used to generate power for the natural gas power generating system 100.

The method 200 can then comprise generating 220 power from the generated steam above in a steam turbine. As described, the heat released by the combustion gases can be transferred to generate steam in the HSRG 110. The steam turbine can be attached to the HSRG 110 and can be similar to those described above. For instance, the generated steam from the HSRG 110 can generate power via the HP turbine 112, the IP turbine 114, and/or the LP turbine 116. As the combustion waste gas proceeds through the HSRG 110, the heat energy is transferred to the steam to generate power in the plurality of steam turbines while removing energy from the waste gas.

The method 200 can then comprise feeding 230 the waste gas stream containing the CO₂ to the PCC unit 130. The cooled waste gas, after flowing through the HSRG 110, can be transported to the PCC unit 130 for CO₂ removal. Based on the power demand on the natural gas power generating system 100, the amount of waste gas being generated for the PCC unit 130 can fluctuate. Therefore, the load on the PCC unit 130 can be altered such that the same amount of CO₂ is being removed from the waste gas regardless of combustion load.

The method 200 can then comprise cleaning 240 the waste gas stream in the PCC unit 130 to obtain a flue gas stream. The flue gas stream can contain a concentration of CO₂ less than the concentration of CO₂ in the waste gas stream. The PCC unit 130 can obtain steam from the HSRG 110 to aid in the carbon capture process therein. As described above, the steam provided to the PCC unit 130 can fluctuate depending on the waste gas generated by the combustion reaction. As such, the PCC unit 130 can obtain a constant level of CO₂ removal from the waste gas regardless of the generation in the gas turbine 120.

The method 200 can then comprise feeding 250 an atmosphere stream to the DAC unit 140. The atmosphere stream can comprise CO₂ from the atmosphere. As described above, the DAC unit 140 can comprise a sorbent bed. The DAC unit 140 can comprise many sorbent beds in the form of a plurality of sorbent modules, which each contain a sorbent bed. The atmosphere stream can comprise atmospheric air that contains CO₂. The atmosphere stream can be fed to the DAC unit 140 continuously.

The concentration of CO₂ in the atmosphere stream can be in the range from approximately 1 ppm to approximately 1000 ppm (e.g., from 10 ppm to 1000 ppm, from 50 ppm to 1000 ppm, from 100 ppm to 1000 ppm, from 200 ppm to 1000 ppm, from 300 ppm to 1000 ppm, from 400 ppm to 1000 ppm, from 500 ppm to 1000 ppm, from 1 ppm to 900 ppm, from 1 ppm to 800 ppm, from 1 ppm to 700 ppm, from 1 ppm to 600 ppm, from 1 ppm to 500 ppm, from 1 ppm to 400 ppm, from 1 ppm to 300 ppm, from 1 ppm to 200 ppm, from 1 ppm to 100 ppm, from 1 ppm to 50 ppm, or from 1 ppm to 10 ppm) based on the total volume of atmospheric air.

The method 200 can then comprise passing 260 the atmosphere stream over the sorbent bed to obtain a stack stream. The stack stream can contain a concentration of CO₂ less than the concentration of CO₂ in the atmosphere stream. As discussed above, the removed CO₂ can be sorbed onto the sorbent bed in the DAC unit 140. The sorbent bed and/or the sorbent module can be maintained at a temperature of 120° C. or less (e.g., from 0° C. to 120° C., from 0° C. to 100° C., from 0° C. to 90° C., from 0° C. to 80° C., from 0° C. to 70° C., from 0° C. to 60° C., from 0° C. to 50° C., from 0° C. to 40° C., from 0° C. to 30° C., from 0° C. to 20° C., or from 0° C. to 10° C.). Further, as described above, the concentration of CO₂ in the atmosphere stream can be in the range from approximately 1 ppm to approximately 1000 ppm.

The sorbed CO₂ can remain on the sorbent bed while accumulating from the atmospheric air. Once the sorbent bed becomes saturated with CO₂, the DAC unit 140 can use steam to regenerate the sorbent bed. The sorbed CO₂ can thereby be removed by the steam and transported for further processing. The determination of when to feed the sorbent bed atmospheric air or steam can be made by a variety of factors as desired, examples of which are described in greater detail below in FIG. 3.

For example, responsive to a power demand on the natural gas power generating system 100 falling below a threshold, the natural gas power generating system 100 can automatically divert a second portion of steam from the plurality of steam turbines in the HSRG 110 to the DAC steam drum to generate steam for the DAC unit 140 by a heat exchange. The DAC steam drum can then conduct the heat exchange to create a regeneration portion of steam and can feed the regeneration portion of steam to the sorbent bed. If the power demand rises above the threshold, the steam diverted from the steam turbines in the HSRG 110 can be re-diverted to generating power in the steam turbines, and the sorbent bed can resume CO₂ removal from the atmospheric air.

The CO₂ removed by both the PCC unit 130 and the sorbent bed in the DAC unit 140 can be transported to a CO₂ compression unit 160 for further processing. For example, the CO₂ can be purified and compressed to obtain product-grade CO₂ to be sold.

FIG. 3 illustrates a flowchart of a method 300 for the capture of carbon dioxide. As described above, the DAC unit 140 can comprise a plurality of sorbent modules each having a sorbent bed. The method 300 is described with respect to a single sorbent module in the DAC unit 140.

The method 300 can begin with the sorbent module in the fresh state 310. In the fresh state 310, the sorbent bed in the sorbent module can be free from CO₂. The adsorption sites on the sorbent bed can be ready to receive CO₂. The sorbent bed can then be put into the carbon capture state 320 as atmospheric air is fed to the sorbent module. The sorbent bed can adsorb 330 CO₂ from the atmospheric air onto the active sites on the sorbent bed. The resulting stack outflow from the sorbent module can contain CO₂ at a concentration less than the concentration of CO₂ in the atmospheric air because CO₂ is removed and retained on the sorbent bed.

The dotted line represents the changeover of the sorbent module from the carbon capture state to the regeneration state 340. The dotted line can represent a number of triggering events that can cause the changeover. For instance, the changeover can occur once the sorbent bed reaches a saturated state in which the sorbent bed is saturated with adsorbed CO₂ and can no longer efficiently remove CO₂ from atmospheric air. However, it is understood that the sorbent bed need not always reach the saturated state for a triggering even to cause the changeover. For instance, a power demand on the natural gas power generating system 100 can fall below a threshold where it is economically more valuable to retrieve the sorbed CO₂ than produce additional power. Regardless, the triggering even can be altered as desired to change the sorbent module from the carbon capture state to the regeneration state 340.

Subsequently, steam from the HSRG 110 (e.g., from the IP/LP crossover 118) cam ne fed to a heat exchanger in the DAC unit 140 steam drum to generate 350 additional steam. The steam can be contained in a water and/or steam loop for the DAC unit 140, and the heat exchange with hot steam from the HSRG 110 can cause the steam to be generated 350. The steam can then contact the sorbent bed in the sorbent module to remove 360 the sorbed CO₂. The steam flow containing the CO₂ can be transported for further processing as described above.

The dotted line then represents the changeover of the sorbent module from the regeneration state 340 to the fresh state 310. Similarly, a number of triggering events can cause the changeover. For instance, the changeover can result from the sorbent bed reaching the fresh state 310 in which the sorbent bed is be free from CO₂. Alternatively, or in addition, the changeover can result from the power demand on the natural gas power generating system 100 rising above the threshold where it becomes economically more valuable to produce power at the steam turbines in the HSRG 110 than to regenerate the sorbent module. Regardless, the triggering even can be altered as desired to change the sorbent module from the regeneration state 340 to the fresh state 310.

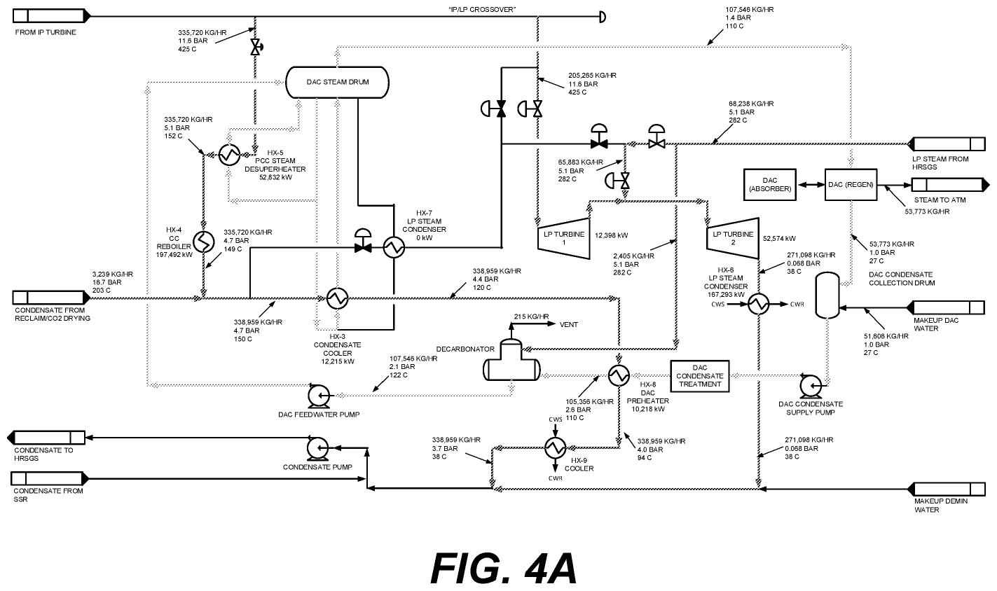

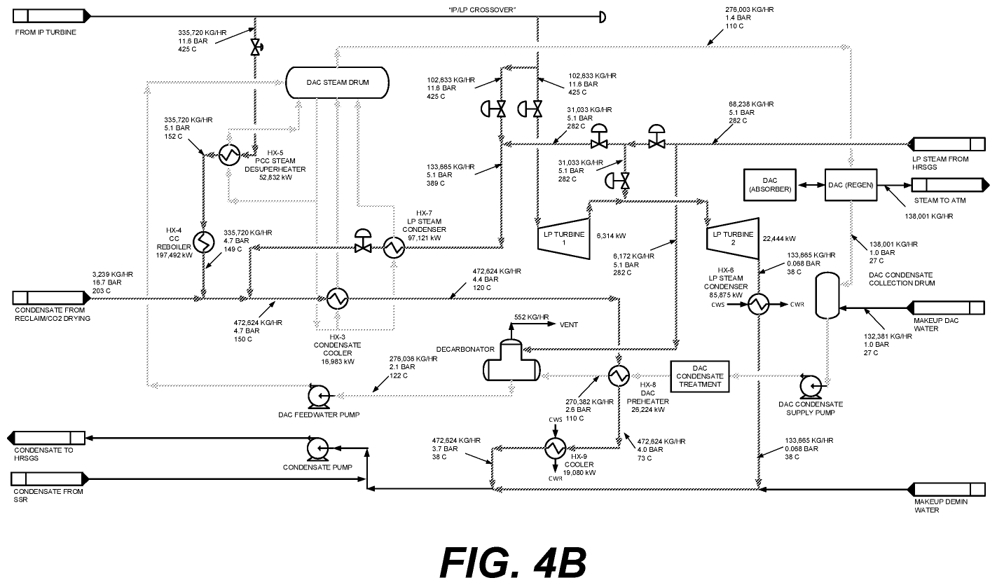

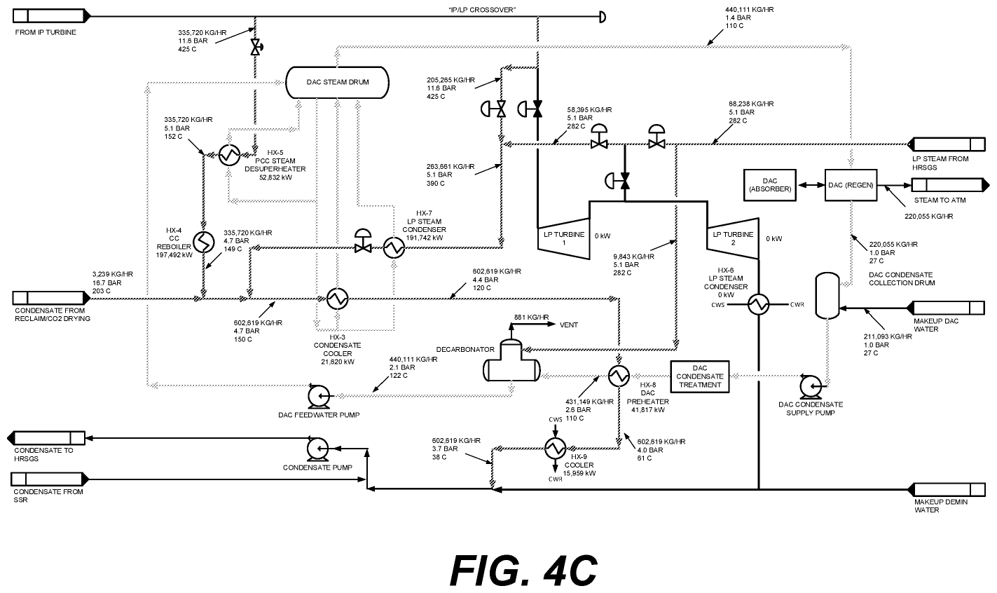

The low-pressure steam flowsheet to support the PCC and DAC system is shown in FIGS. 4A-C. The flowsheet in FIG. 4A illustrates the scenario where the disclosed systems can maximize the electrical power output. The steam and condensate lines that are being supplied to the PCC system components (Regenerator Reboiler, Reclaim and CO₂ Drying) are colored in red. Since the flowrate of these streams is a function of the CO₂ that is being captured in the PCC system, they can remain constant whether the unit is producing the maximum power or removing the maximum CO₂. Notice that the steam that flows to the PCC Regenerator Reboiler is desuperheated in HX-5 by generating steam for the DAC system. After the LP steam is utilized in the PCC Regenerator Reboiler, the condensate can be combined with the condensate from the Reclaim/CO₂ drying and used to generate additional DAC steam in the Condensate Cooler, HX-3. Therefore, even for the “Maximum Power” case, some DAC steam can be generated, and the unit can remove CO₂ from the atmosphere.

The blue lines in FIG. 4A represent the steam and condensate that are utilized for generating power in the LP Turbine. The LP steam that is not being utilized by the PCC system can flow to the LP Turbine from the IP/LP crossover. Since the pressure of this steam is higher than the steam being generated by the HRSG, this steam can be expanded in LP Turbine 1 to match the pressure of the LP steam exiting the HRSG. These two streams can combine and flow through LP Turbine 2. The exhaust steam can be condensed in HX-6 and returned to the HRSG. A small portion of the LP steam from the HRSGs can be supplied to the Decarbonator to degas the DAC Condensate.

The orange lines in FIG. 4A represent the steam/condensate for DAC system. The steam that is generated in the natural circulating steam generators (HX-3 and HX-5) can be separated from the circulating water in the DAC Steam Drum and then used to regenerate the DAC System. It can be expected that half of the steam entering the DAC unit would be lost to the atmosphere and the other half would be recovered in the DAC Condensate Collection Drum and recycled. Makeup water can be added to the DAC Condensate Collection Drum to maintain the water inventory necessary in the DAC Steam Generation System. The combined stream would be pumped through a DAC Condensate Treatment System which can remove any impurities from the recovered condensate and adjust the pH of the water. The condensate leaving the DAC Condensate Treatment system can be pre-heated in HX-8 using the warm condensate from HX-3 before entering the Decarbonator. This preheating can minimize the amount of steam needed to heat the condensate to saturation temperature in the Decarbonator. LP steam from the HRSGs can be used to complete the heating of the DAC condensate to saturation in order to “degas” the CO₂ that was dissolved into the water during the regeneration process. The condensate exiting the Decarbonizer can be pumped back to the DAC Steam Drum to be used as feedwater for the natural circulation steam generation system.

To increase the generation of the DAC steam, the LP steam used in the LP Turbine for the Maximum Power case can be re-directed to HX-7 to generate additional DAC steam. FIG. 4B shows the scenario where the LP steam system can be transitioning from Max Power to Max DAC and 50% of the steam from the IP/LP crossover and 50% of the LP steam from the HRSGs (after extracting the steam for the Decarbonator) can be diverted to HX-7 and the remaining steam to the LP Turbine.

As the combined steam flows through HX-7, additional DAC steam can be generated. The exchanger can condense the LP steam using its latent heat to generate DAC steam. The condensate from HX-7 can combine with the condensate from the PCC system, thereby increasing the steam generation in HX-3. The combined condensate streams can provide preheating for the DAC condensate in HX-8 and would be returned to the HRSG.

FIG. 4C shows the scenario where all the LP steam that was not being utilized by the PCC system can be utilized to generate DAC steam in HX-7. In this scenario, there would be no steam flowing to the steam turbine.

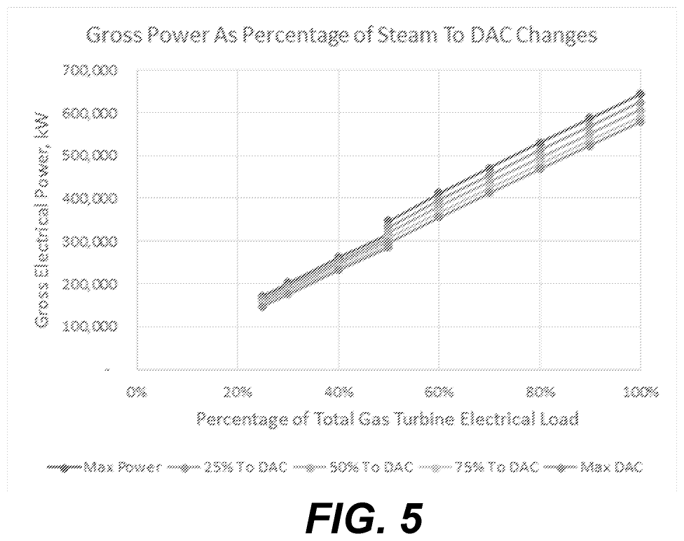

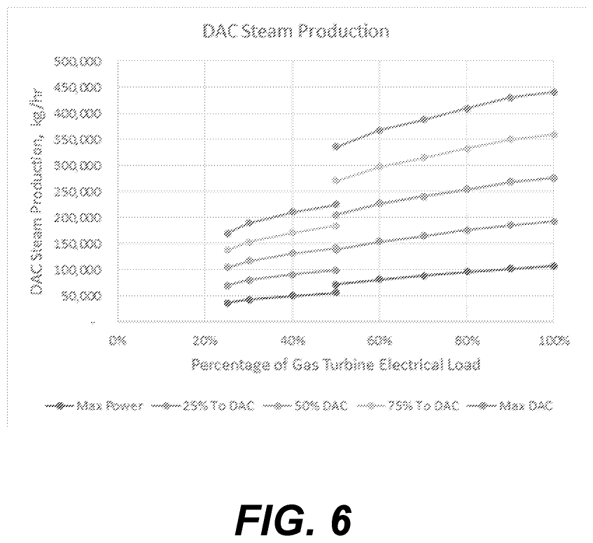

The change in gross power generated as the split of the DAC steam from the LP Turbine to HX-7 is varied is shown in FIG. 5. Varying the LP steam flow to the LP Turbine from 0 to 100% can increase the total gross power by approximately 65 MW, approximately 10% of the total gross power However, as shown in FIG. 6, the amount of DAC steam generated can increase as much as 400% if all the LP steam is diverted form the LP Turbine to HX-7.

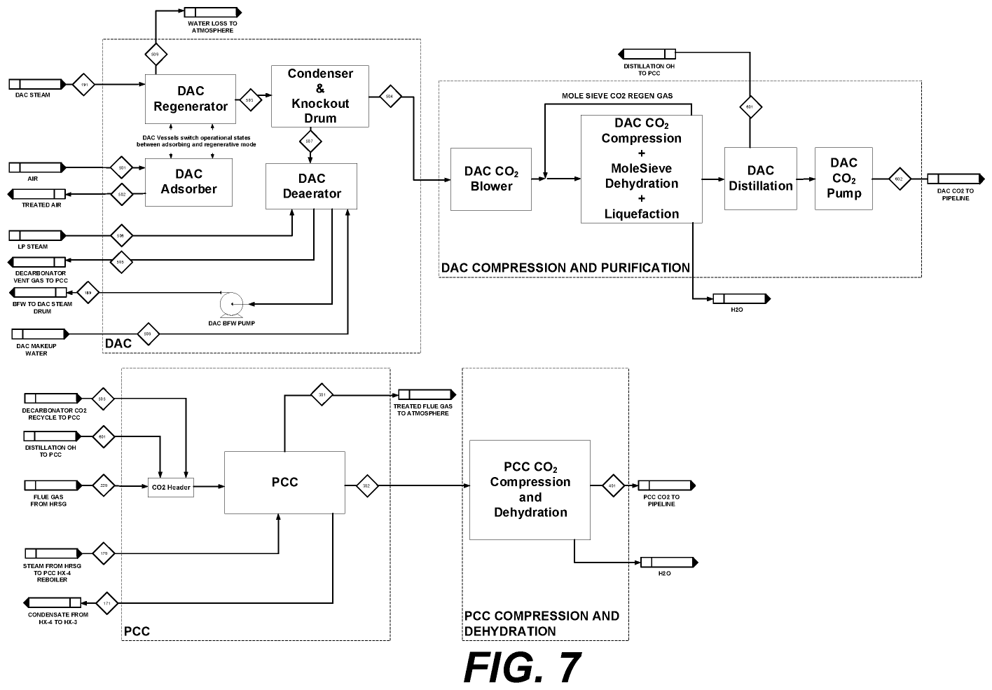

In addition, the present disclosure can extend the PCC Cansolv system from capturing 90% of the flue gas CO₂ to capture 97% and estimate the cost and energy implications of this change. The disclosed flexible compression and purification system for the PCC and DAC capture can allow the disclosed systems to run at variable loads and very low to maximum levels of DAC. The block diagram of this system is given in FIG. 7. Going forward, the PCC and flexible purification and compression systems can be scaled for different NGCC systems and costs developed for different levels of capture as well as unit sizes. The start-up procedure can be refined to improve fidelity and performance but already captures the main features and the implications for CO₂ emissions.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

The present disclosure can include some or all of the following features with respect to the design of the PCC system.

Three solvents can be used as potential candidates for a solvent-based amine capture system: MEA, concentrated piperazine, and Shell's Cansolv solvent. While MEA is widely used in similar applications with a transparent data set for CO₂ capture, the MEA solvent was not selected because it is a first-generation amine solvent with a higher reboiler duty. Without wishing to be bound by any particular scientific theory, it is less likely to be competitive in a net-zero grid framework. Concentrated piperazine can have the lowest reboiler duty of the three solvents considered herein, but there was no open-source model available for piperazine and limited cost data. The Shell Cansolv system can have a significantly lower reboiler duty than MEA (though somewhat higher than piperazine), and there are publicly available cost models for the Cansolv system.

A CO₂ capture rate of 97% can be achieved for the amine system. A capture rate of 90% capture can also be achieved herein, but a baseline level of capture of interest has recently shifted to 95% and beyond. Based on published data for MEA and piperazine, the reboiler duty (on a GJ/tonne CO₂ basis) for these solvents can be relatively flat from 90% capture up to 95% capture, while reboiler duty is much higher at 99% capture. The present disclosure can have a reboiler duty between 95 and 99% capture; however, 97% CO₂ capture can also be achieved without significant penalty in reboiler duty (on a GJ/tonne or MMBtu/tonne CO₂ basis). Therefore, as disclosed herein, the design can be made to target 97% CO₂ capture with an amine system, with a preliminary assumption that reboiler duty on a GJ/tonne CO₂ basis can be the same as at, for example, 90% CO₂ capture.

As disclosed herein, 100% of the flue gas from the HRSG can be treated by the PCC at all NGCC operating loads, with the exception of startup. The flue gas flow rate can vary with ambient temperature, with more flue gas generated at lower ambient temperatures and less flue gas generated at higher ambient temperatures. To treat 100% of the flue gas over the range of flue gas flow rates, a leak-tight damper can be used on the HRSG stack. This damper can prevent flue gas from short-circuiting the carbon capture system to exit via the HRSG stack, and it can prevent air ingress via the stack. Such a damper can be fast-acting to open in case of a shutdown of the carbon capture units (e.g., flue gas fan fails) so that back-pressure does not build on the HRSG. Other engineering solutions beside such a damper can be possible and are contemplated; the appropriate solution can be explored further along with the process concept in a detailed design phase.

The NGCC operating scenarios that can set some exemplary limits for a maximum and a minimum CO₂ processing rate by the PCC can be: 2 gas turbines×100% load, which sets the maximum CO₂ rate to the PCC unit, 250 tonne CO₂/hr; 1 gas turbine×50% load, which can set the minimum CO₂ rate to the PCC unit, 78 tonne CO₂/hr. The turndown required from maximum PCC CO₂ rate can be 31%.

The presently disclosed NGCC units can include, for instance, two amine absorbers due to the large volume of flue gas to be treated. Absorption columns can achieve 50% turndown, and thus two columns can achieve the required turndown of 310%. If needed, a single absorber column can be designed for lower turndown (˜33%) via design of the liquid distributors.

The design decisions for the PCC compression can be related to enabling flexible operation of the compression system. Flexible operation can include being able to operate the compressors between the minimum and maximum CO₂ flow rates and being able to start and stop the compression system when the NGCC is taken offline and brought online.

The NGCC operating scenarios that can set exemplary limits for the maximum and minimum CO₂ processing rates by the PCC Compressor are: 2 gas turbines×100% load, which can set the maximum CO₂ rate to the PCC unit, 250 tonne CO₂/hr; 1 gas turbine×50% load, which can set the minimum CO₂ rate to the PCC unit, 78 tonne CO₂/hr. The turndown required from maximum PCC CO₂ rate can be 31%.

The present disclosure can include some or all of the following features with respect to the design of the PCC compression system.

One exemplary limiting factor in the turndown of the PCC unit can be associated with the PCC CO₂ compressor. The TEG dehydration can achieve 25% turndown on the gas side, but the turndown of the compressors can be nominally 75% for integrally-geared compressors. Present examples of a CO₂ compressor can include two parallel integrally-geared compressor trains, which can offer overall system turndown to approximately 38%. To achieve the required turndown of 31% for the very lowest gas turbine loads, CO₂ can be recycled to the front end of the compressor to maintain volumetric flow through the compressor. This recycle stream can increase the power requirement of the compressor. When the NGCC is operating in the Max DAC condition, power prices are expected to be low, so some increased auxiliary load due to CO₂ recycling can be tolerated. The electricity consumption values for PCC Compression included a recycle penalty for the integrally-geared compressors for low operating loads.

The present disclosure can include implementing and designing centrifugal and reciprocating compression equipment for multiple starts and stops. A compressor can be designed for 1,000 starts over a 20-year design life. Large-scale industrial plants can operate for one to seven years without maintenance shutdowns, so compressor equipment can often be designed for long continuous run-times without maintenance. The compressors can be readily designed for many starts and stops; since these large compressors can be custom engineered products, the compressor can be engineered for parts to have the appropriate thicknesses and materials of construction to accommodate the stress associated with many starts and stops. In addition, variable frequency drives (VFDs) can be added to the compressor to slow the startup process and further reduce mechanical stresses. Variable frequency drives (VFDs) can be used to mitigate grid brownouts that can occur when large compressors come on-line. Adding 15% to the capital cost of the compressor plus motor can be a first approximation to cover the cost of a VFD and additional engineering of materials; the cost for one VFD per compressor can be incorporated into the system cost model. A single VFD can startup multiple motors, if ratings are compatible and the startup can be staged.

The PCC unit can become a bottleneck for CO₂ abatement relative to the power plant start-up sequence. —At such a point, the power plant can be producing flue gas that could be treated by the PCC, but the solvent cannot be regenerated, resulting in the CO₂ being emitted unabated. The availability of steam and the steam conditions from the power plant, the solvent inventory, and the thermal mass of the piping and reboiler can be factors in determining the time to reach the steady-state solvent regeneration temperature.

The present disclosure on flexible operation of PCC units can include concepts such as lean solvent storage to decouple the regeneration and absorption system (and effectively decouple CO₂ capture from the power plant for limited periods of time). Flexible PCC concepts such as lean solvent storage can use additional capital investment and can utilize a careful cost-benefit analysis to determine the value of the concepts. This can represent a potential optimization after understanding the dispatch behavior of the NGCC with PCC (and direct air capture

The DAC process block can include the DAC sorbent beds, which can alternate operation between absorption and regeneration modes, a condenser, a knockout drum to process the CO₂ leaving the regenerator, and a Deaerator to remove dissolved gases (CO₂, air) from the condensed water that is returned to the DAC steam cycle. The vent stream from the deaerator can be recycled to the PCC to recover the CO₂ in the vent stream; however, at 2×100% load Max DAC conditions, the CO₂ in this stream is very small (221 kg/hr) compared to the CO₂ captured in the DAC (134,000 kg/hr). The cost of the PCC system does not include the ductwork to convey this CO₂ to the PCC. The cost of the ductwork to convey the deaerator vent CO₂ to the PCC can be dependent upon the relative layouts of the DAC and PCC and could be quite significant.

The present disclosure can include some or all of the following features with respect to the design of the DAC Purification and Compression systems.

The CO₂ product specification can depend upon whether the CO₂ will be transported through commercial carbon steel pipeline, used for enhanced oil recovery, and/or sequestered in a saline reservoir. As disclosed herein, the relevant species of interest and their conceptual design values in the QGESS CO₂ specification can include: CO₂ (>95 mol %), H₂O (<500 ppmv), N₂ and Ar (<1 to 4 mol %, depending on CO₂ disposition), and O₂ (<10 ppmv). For each of these species, the QGESS can also provide a range of specification values that can be found in literature. The concentrations of inerts such as N₂ and Ar can be capped to reduce the volumetric flow rate of the CO₂ stream and thus reduce the power required to compress the CO₂ stream and reduce the mass of inerts in the storage formation. Limits on O₂ in the CO₂ product can be driven by concerns about the reactivity of O₂ in the geological formation.

The CO₂ streams produced by the DAC unit can contain oxygen as an impurity at concentrations of from 4,000 to 5,000 ppmv, which can exceed the conceptual design values in the QGESS CO₂ specifications. However, in practice, there is no single technical standard for O₂ in CO₂ that is geologically sequestered. Uncertainty about subsurface impacts and varying risk tolerance among project developers can lead to a wide range of O₂ limit specifications between projects. Use of liquefaction and distillation to meet an O₂ specification can significantly increase the electricity and purchased equipment costs of the purification system. As disclosed herein, the disclosed systems can include a design to a limit of 10 ppmv O₂ in the CO₂, which can align with the QGESS specification and the specification for CO₂ entering a common carrier pipeline. If disclosed systems have a project-dedicated pipeline and the sequestration chemistry were favorable, higher O₂ limits than 10 ppmv can be theoretically supported.

CO₂ that carries off-specification concentrations of inerts (O₂, N₂) can be processed by liquefaction and distillation. The present disclosure can utilize commercial-scale liquefaction and distillation units, such as those used for the food and beverage grade industry. There can potentially be other technology options for inerts removal from the CO₂, such as a catalytic process to remove O₂. Therefore, as disclosed herein, a liquefaction/distillation process can be proposed.

For the DAC unit, the operating scenarios of interest are: 2 gas turbines×100% load, Max DAC, which sets the maximum CO₂ rate to the DAC system, 138 tonne CO₂/hr; 2 gas turbine×100% load, Max Power, which sets the minimum CO₂ flow rate to the DAC system, 33 tonne CO₂/hr. The turndown required from maximum DAC CO₂ rate is 24%.

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

1. A natural gas power generating system comprising:
a gas turbine;
a heat recovery steam generator (HRSG) configured to recover heat from operation of the gas turbine;
a post-combustion carbon capture (PCC) unit configured to remove carbon dioxide from operation of the gas turbine; and
a direct air capture (DAC) unit configured to:
conduct a heat exchange with at least a portion of steam from operation of the PCC unit; and
adsorb carbon dioxide from an atmosphere stream.

2. The natural gas power generating system of claim 1, wherein:
the gas turbine is configured to generate power and generate a waste gas as a result of a combustion reaction between natural gas and air, the gas turbine comprising:
an air inlet;
a natural gas inlet; and
a gas turbine outlet line;
the HRSG is configured to recover heat from the waste gas by transferring heat energy from the waste gas to water to generate steam, the HRSG comprising:
a waste gas inlet line connected to the gas turbine outlet line;
steam outlet lines; and
an HRSG outlet line;
the PCC unit is configured to remove carbon dioxide from the waste gas to create a flue gas, the PCC unit comprising:
a PCC inlet line connected to the HRSG outlet line;
a flue gas outlet line vented to atmosphere; and
a first carbon dioxide rich outlet line configured to transport carbon dioxide product removed by the PCC unit;
the DAC unit comprises:
a DAC steam generation system comprising a heat exchanger configured to generate steam from an exchange of heat from steam generated by the HRSG;
a sorbent bed;
an atmosphere inlet line;
a second carbon dioxide rich outlet line configured to transport carbon dioxide product removed by the DAC unit; and
a stack outlet line vented to atmosphere.

3. The natural gas power generating system of claim 2 further comprising:
steam turbines configured to generate power from steam generated by the HRSG; and
a compression unit configured to compress the carbon dioxide from the DAC unit and the PCC unit;
wherein the second carbon dioxide rich line is configured to transport carbon dioxide product removed by the DAC unit to a Purification unit; and
wherein the steam outlet lines:
are configured transport steam from the HRSG to the steam turbines; and comprise:
a high pressure outlet that feeds into a high pressure (HP) turbine;
an intermediate pressure outlet that feeds into an intermediate pressure (IP) turbine; and
a low pressure outlet that feeds to a low pressure (LP) turbine, wherein the LP turbine comprises an IP/LP crossover configured to transport additional steam from the IP turbine to the LP turbine.

4. The natural gas power generating system of claim 3, wherein the IP/LP crossover comprises a carbon capture steam line configured to transport steam from the IP/LP crossover to the PCC unit.

5. (canceled)

6. The natural gas power generating system of claim 4, wherein the DAC unit further comprises a sorbent module containing the sorbent bed; and
wherein the sorbent module has:
a carbon capture state configured to adsorb carbon dioxide on the sorbent bed and
a regeneration state configured to contact steam from the DAC steam generation system with the sorbent bed.

7. The natural gas power generating system of claim 6, wherein the DAC unit automatically transitions the sorbent module from the carbon capture state to the regeneration state when the sorbent bed is at least partially saturated with carbon dioxide.

8. The natural gas power generating system of claim 7, wherein the DAC unit automatically transitions the sorbent module from the carbon capture state to the regeneration state at a rate which steam contacts the sorbent bed in the regeneration state is altered based on a price of electricity produced by the natural gas power generating system.

9. The natural gas power generating system of claim 6, wherein the DAC unit further comprises one or more additional sorbent modules, each additional sorbent module containing a sorbent bed; and
wherein each additional sorbent module is either in the carbon capture state or the regeneration state.

10. The natural gas power generating system of claim 6, wherein steam generated by the HRSG is configured to provide steam to the heat exchanger of the DAC steam generation system in the regeneration state; and
wherein at least a portion of steam generated by the HRSG is further configured to simultaneously be provided to the PCC unit.

11. (canceled)

12. The natural gas power generating system of claim 3, wherein the compression unit comprises;
a first compression unit configured to compress carbon dioxide from the DAC unit; and
a second compression unit configured to compress carbon dioxide from the PCC unit.

13. A natural gas power generating system comprising:
a post-combustion carbon capture (PCC) unit configured to remove carbon dioxide from a waste gas to create a flue gas, the PCC unit comprising a waste gas inlet line, a flue gas outlet line, and a first carbon dioxide rich outlet line;
a direct air capture (DAC) unit configured to adsorb carbon dioxide from an atmospheric gas, the DAC unit comprising a sorbent bed, an atmosphere inlet line, a second carbon dioxide rich outlet line, and a stack outlet line; and
a compression unit configured to receive at least one of: carbon dioxide gas from the first carbon dioxide rich outlet line and carbon dioxide gas from the second carbon dioxide rich outlet line to create a compressed carbon dioxide product;
wherein the stack outlet line is vented to the atmosphere by a stack.

14. The natural gas power generating system of claim 13 further comprising:
a plurality of steam turbines configured to generate power from steam; and
a heat recovery steam generator (HRSG) comprising a high pressure outlet, an intermediate pressure outlet, and a low pressure outlet, each of which is configured transport steam from the HRSG to the plurality of steam turbines;
wherein the high pressure outlet feeds into a high pressure (HP) turbine, the intermediate pressure outlet feeds into an intermediate pressure (IP) turbine, and the low pressure outlet feeds to a low pressure (LP) turbine, wherein the LP turbine comprises an IP/LP crossover configured to transport additional steam from the IP turbine to the LP turbine; and
wherein the DAC unit further comprises a sorbent module containing the sorbent bed, wherein the sorbent module has: a carbon capture state wherein the sorbent module is configured to adsorb carbon dioxide on the sorbent bed, and a regeneration state wherein the sorbent module is configured to contact steam from a DAC steam generation system with the sorbent bed.

15. (canceled)

16. The natural gas power generating system of claim 14, wherein the IP/LP crossover comprises a carbon capture steam line configured to transport steam from the IP/LP crossover to the PCC unit.

17. The natural gas power generating system of claim 14 further comprising a DAC steam generation system comprising a heat exchanger configured to generate steam from the exchange of heat from steam generated by the HRSG.

18. (canceled)

19. The natural gas power generating system of claim 14, wherein the DAC unit automatically transitions the sorbent module from the carbon capture state to the regeneration state when the sorbent bed is at least partially saturated with carbon dioxide.

20. The natural gas power generating system of claim 14, wherein the DAC unit automatically transitions the sorbent module from the carbon capture state to the regeneration state when the sorbent bed is at least partially saturated with carbon dioxide, and a rate at which steam contacts the sorbent bed in the regeneration state is altered based on a price of electricity produced by the natural gas power generating system.

21. The natural gas power generating system of claim 17, wherein the steam generated by the HRSG is configured to provide steam to the heat exchanger in DAC steam generation system in the regeneration state, and at least a portion of the steam generated by the HRSG is further configured to simultaneously be provided to the PCC unit.

22. A method for the capture of carbon dioxide, the method comprising:
combusting a natural gas to obtain a waste gas stream containing carbon dioxide, the combustion reaction generating heat to generate steam;
using at least a portion of the generated steam to generate power through a steam turbine;
feeding the waste gas stream containing the carbon dioxide to a post-combustion carbon capture (PCC) unit;
cleaning the waste gas stream to obtain a flue gas stream containing a concentration of carbon dioxide less than the concentration of carbon dioxide in the waste gas stream;
feeding an atmosphere stream to a direct air capture (DAC) unit comprising a plurality of sorbent modules, each of which comprises a sorbent bed, the atmosphere stream comprising carbon dioxide from the atmosphere; and
passing the atmosphere stream over the sorbent bed in each of the plurality of sorbent modules to obtain a stack stream containing a concentration of carbon dioxide less than the concentration of carbon dioxide in the atmosphere stream.

23. The method of claim 22 further comprising:
responsive to a demand in electricity falling below a predetermined threshold, diverting the at least a portion of generated steam from the steam turbine to a steam generation system connected to the DAC unit;
conducting a heat exchange between the at least a portion of generated steam and a regeneration portion of steam contained in the steam generation system;
automatically stopping the atmosphere stream from being fed into the DAC unit; and
regenerating the sorbent beds in a portion of the plurality of sorbent modules by contacting the regeneration portion of steam from the steam generation system with the sorbent beds to obtain a concentrated carbon dioxide stream.

24. The method of claim 23 further comprising:
responsive to the demand in electricity rising above the predetermined threshold,
automatically resuming the feeding of the atmosphere stream to the portion of the plurality of sorbent modules; and
re-diverting the at least a portion of generated steam to the steam turbine;
wherein the concentration of carbon dioxide in the atmosphere stream is in the range from 100 to 1000 ppm; and
wherein the Passing the atmosphere stream over the sorbent bed occurs at a substantially ambient temperature of not greater than 60° C.

25.-26. (canceled)
